(19) United States
(12) Patent Application Publication
(10) Pub. No.: US 2011/0080760 A1
(43) Pub. Date: Apr. 7, 2011

(54) Rectifier driving circuit

(76) Inventor: Chao-Cheng Lu, Taipei (TW)

(21) Appl. No.: 12/587,126

(22) Filed: Oct. 2, 2009

(51) Int. Cl. H02M 7/217

(52) U.S. Cl. 363/127

(57) ABSTRACT

A rectifier driving circuit of the present invention, has a first driving element and a second driving element, switching element comprises a FET, a first driving element comprises the voltage drop resistor, a second driving element comprises the series-connected circuit of the diodes, the driving element for driving a FET, may be achieved rectify function.

### BACKGROUND OF THE INVENTION

1. Field of the Invention

The present invention related to a first driving element, a second driving element and an enhancement mode FET for rectifier driving circuit, especially FET there is not an intrinsic body diode can be achieve rectify function.

2. Description of Related Arc

FIG. 7 shown a structures of the prior art half-wave rectifier. In this figure, FET F1 is responsible for rectification. In operation, when positive of AC power source in the terminal A, terminal B is negative, FET F1 turned on, FET F1 acts as a rectifier, the path of the current flow is from terminal A of AC power source though a load LD, FET F1 and back to terminal B; when negative of AC power source in the terminal A, terminal B is positive, FET F1 turned off, the path of the current flow is from terminal B of AC power source though intrinsic body diode DB of the FET F1, a load LD and back to terminal A, may be burnout by current of the prior art FET F1, and FET F1 having no responsible for rectification.

### SUMMARY OF THE INVENTION

In order to provide a first driving element, a second driving element FET having no intrinsic body diode that may elevate the efficiency of half-wave rectifier, the present invention is proposed the following object:

The first object of the present invention provide a driving circuit for a rectifier, in which the rectifier simplicity is improved.

The second object of the present invention provide a diode parallel to the FET for surge current protection.

According to the defects of the prior art technology discussed above, a novel solution, the rectifier driving circuit is proposed in the present invention, which provides simplicity and for surge current protection in rectifier circuit.

### BRIEF DESCRIPTION OF THE DRAWINGS

FIG. 1 shown the structures of a prior art N-Channel FET.

FIG. 2 shown the structures a having no intrinsic body diode N-Channel FET.

FIG. 3 shown the structures of a diode parallel to the N-Channel FET, a P-junction of the diode connected to drain of the N-Channel FET, a N-junction of the diode connected to source of the N-Channel FET.

FIG. 4 shown the structures of a prior art P-Channel FET.

FIG. 5 shown the structures a having no intrinsic body diode P-Channel FET.

FIG. 6 shown the structures of a diode parallel to the P-Channel FET, a N-junction of the diode connected to drain of the P-Channel FET, a P-junction of the diode connected to source of the P-Channel FET.

FIG. 7 is a circuit diagram of a prior art N-Channel FET for half-wave rectifier circuit.

FIG. 8 is a circuit diagram of a first embodiment of the present invention.

FIG. 9 is a circuit diagram of a second embodiment of the present invention.

### DETAILED DESCRIPTION OF THE PREFERRED EMBODIMENTS

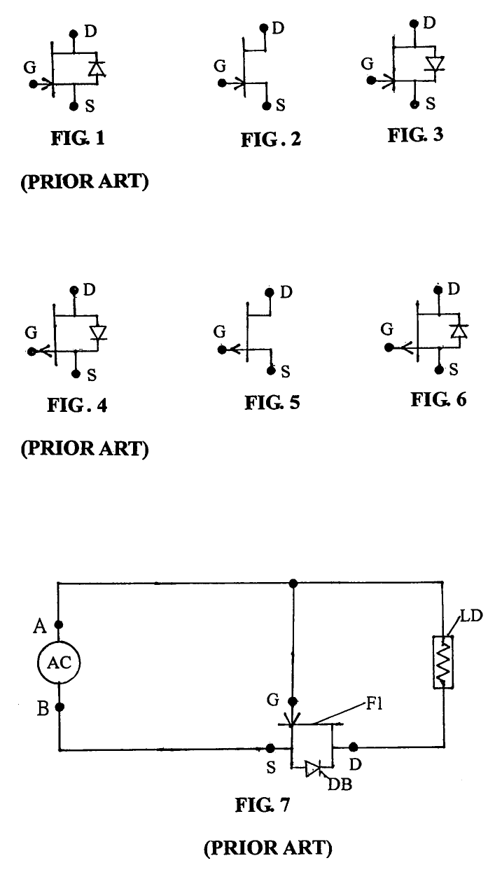

FIG. 1 shows the structures of a prior art N-Channel FET, a N-junction of the intrinsic body diode DB connected to drain of the prior art N-Channel FET, a P-junction of the intrinsic body diode DB connected to source of the prior art N-Channel FET.

FIG. 2 shows the structures of a N-Channel FET having no intrinsic body diode, has a enhancement mode FET.

FIG. 3 shows the structures of a diode parallel to the N-Channel FET, a diode parallel to the N-Channel FET for surge current protection in the rectify circuit.

FIG. 4 shows the structures of a prior art P-Channel FET, a P-junction of the intrinsic body diode DB connected to drain of the prior art P-Channel FET, a N-junction of the intrinsic body diode DB connected to source of the prior art P-Channel FET.

FIG. 5 shows the structures of a P-Channel FET having no intrinsic body diode, has a enhancement mode FET.

FIG. 6 shows the structures of a diode parallel to the P-Channel FET, a diode parallel to the P-Channel FET for surge current protection in the rectify circuit.

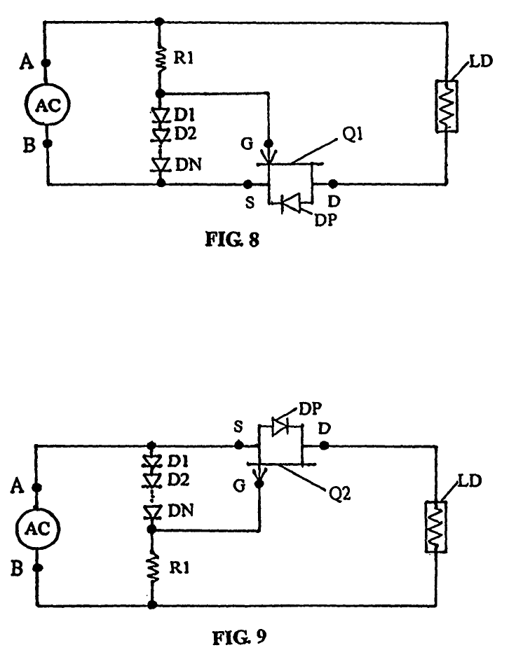

As shown in FIG. 8, has a AC power source input terminal, a first terminal A and second terminal B of the input terminal, a N-Channel FET Q1, a first driving element R1, a second driving element D1, D2 . . . DN, and a load LD.

A inrush diode DP parallel to the N-Channel FET Q1 shown in FIG. 8, a driving circuit comprises a voltage drop resistor R1 and a diode D1 or series-connected with D1, D2 . . . DN diodes; the P-junction of D1, D2 . . . DN diodes connected to gate of the N-Channel PET Q1, the N-junction of D1, D2 . . . DN diodes connected to source of the N-Channel FET Q1, the driving voltage is equal to the forward voltage of series-connected of D1, D2 . . . DN diodes.

As shown in FIG. 8, when positive of AC power source in the terminal A, terminal B is negative, the P-junction is positive of the series-connected D1, D2 . . . DN diodes, the N-junction is negative of the series-connected of D1, D2 . . . DN diodes, the N-Channel FET Q1 is turned on, the driving voltage is equal to the forward voltage of series-connected of D1, D2 . . . DN diodes, the path of the current flows is from terminal A of the AC power source though a load LD, a N-Channel FET Q1, and back to terminal B of the AC power source.

As shown in FIG. 8, when negative of AC power source in the terminal A, terminal B is positive, the P-junction is negative of the series-connected of D1, D2 . . . DN diodes, the N-junction is positive of the series-connected of D1, D2 . . . DN diodes, the N-Channel FET Q1 is turned off, the rectifier is open circuit.

As shown in FIG. 9, has a AC power source input terminal, a first terminal A and second terminal B of the input terminal, a P-Channel FET Q2, a first driving element R1, a second driving element D1 . . . DN, and a load LD.

A surge diode DP parallel to the P-Channel FET shown in FIG. 9, a driving circuit comprises a voltage drop resistor R1 and a diode D1 or series-connected with D1, D2 . . . DN diodes; the N-junction of D1, D2 . . . DN diodes connected to gate of the P-Channel PET Q2, the P-junction of D1, D2 . . . DN diodes connected to source of the P-Channel PET Q2, the driving voltage is equal to the forward voltage of series-connected of D1, D2 . . . DN diodes.

As shown in FIG. 9, when positive of AC power source in the terminal A, terminal B is negative, the P-junction of the diode D1 is positive of the series-connected D1, D2 . . . DN diodes, the N-junction of the diode DN is negative of the series-connected of D1, D2 . . . DN diodes, the P-Channel FET Q2 is turned on, the driving voltage is equal to the forward voltage of series-connected of D1, D2 . . . DN diodes, the path of the current flows is from terminal A of the AC power source though a P-Channel FET Q2, a load LD, and back to terminal B of the AC power source.

As shown in FIG. 9, when negative of AC power source in the terminal A, terminal B is positive, the P-junction is negative of the diode D1 of the series-connected of D1, D2 . . . DN diodes, the N-junction of the diode DN is positive of the series-connected of D1, D2 . . . DN diodes, the P-Channel FET Q2 is turned off, the rectifier is open circuit.

The operation principle of the second driving element D1, D2 . . . DN of FIG. 8 and the second driving element D1, D2 . . . DN of FIG. 9 is same, both of the second driving element can be use a series-connected circuit of diode and zener diode replace, the driving voltage is equal to the forward voltage of diode and zener voltage of zener.

What is claimed is:

1. A rectifier driving circuit, comprises:
a first driving element for voltage drop;
a second driving element for driving gate-source of FET; and
a FET having no body diode and can be achieve rectify function.

2. A rectifier driving circuit as in claim 1, wherein:
said a first and a second driving element comprises the series-connect circuit of resistor and diode

3. A rectifier driving circuit as in claim 1, wherein:
said a first driving element comprise a resistor.

4. A rectifier driving circuit as in claim 1, wherein:
said a second driving element comprises a diode.

5. A rectifier driving circuit as in claim 1, wherein:
said a second driving element comprises the series-connect circuit of two diodes or more diodes.

6. A rectifier driving circuit as in claim 1, wherein:
said a second driving element comprises series-connect circuit of diode and zener diode.

7. A rectifier driving circuit as in claim 1, wherein:
said second terminal of a first driving element and first terminal of a second driving element connected together to said gate of the FET.

8. A rectifier driving circuit as in claim 1, wherein:
said driving circuit comprises a first and a second driving element.

9. A rectifier driving circuit as in claim 8, wherein:
said driving circuit connected to said first and second AC power source input terminal.

10. A rectifier driving circuit as in claim 1, wherein:
said a FET of N-Channel type parallel to a diode; and
P-junction node of said a diode connected to drain node of said a FET of N-Channel type, and N-junction node of said a diode connected to said source node of said a FET of N-Channel type.

11. A rectifier driving circuit as in claim 1, wherein:
said a FET of P-Channel type parallel to a diode; and
N-junction node of said a diode connected to drain node of said a FET of P-Channel type, and P-junction node of said a diode connected to said source node of said a FET of P-Channel type.

12. A rectifier driving circuit as in claim 1, wherein:
said first terminal of a first driving element and said first terminal of a load connected together to said first AC power source input terminal;
said second terminal of a first driving element and said first terminal of a second driving element connected together to said gate of N-Channel FET;
said second terminal of a second driving element and said source of N-Channel FET connected together to said second AC power source in put terminal; and
said drain of N-Channel FET connected to said second terminal of a load.

13. A rectifier driving circuit as in claim 1, wherein:
said second terminal of a second driving element and said source of P-Channel FET connected together to said first AC power source input terminal;
said first terminal of a second driving element and said second terminal of a first driving element connected together to said gate of P-Channel FET;
said first terminal of a first driving element and said second terminal of a load connected together to second of AC power source input terminal; and
said drain of P-Channel FET connected to said first terminal of a load.
